(19) United States
(12) Patent Application Publication
(10) Pub. No.: US 2010/0314898 A1
(43) Pub. Date: Dec. 16, 2010

(54) Multi-purpose storage container

(76) Inventor: David Hawkinson, Girard, IL (US)

Correspondence Address: GEORGE E. BULLWINKEL, 425 WOODSIDE AVENUE, HINSDALE, IL, 60521, US

(21) Appl. No.: 12/456,036

(22) Filed: Jun. 10, 2009

(51) Int. Cl. B60R 5/00

(52) U.S. Cl. 296/37.6

(57) ABSTRACT

A multi-purpose container adapted to be carried by a wheeled vehicle, such as a pick-up truck or utility type trailer, or used by itself in a fixed location. In its alternative embodiments the container may be used for fixed storage or transport of goods. The container comprises cooperating structural elements including a floor, side and end walls and a roof, which elements are separately formed from suitable structural material such as foam-core panels or structural-grade sheet plastic and assembled by suitable joining means. An openable door panel completes the structure. Alternatively, the structural elements are formed as an integral unit from blow-molded structural-grade plastic or molded fiberglass, with a cut-in door opening and separately attachable door panel. The container features rain-shielded ventilation openings and reinforced hard points for securing the assembled unit to the bed of a vehicle, and for securing cargo within the container during transport. In an alternative embodiment, the container is constructed as two symmetrical half-shells about a horizontal plane which are nestable within one another for storage or shipment.

### FIELD OF THE INVENTION

This invention pertains to lightweight portable storage containers adapted to be conveniently carried in the bed of a pick-up truck, or on a lightweight trailer, or even used by itself as an inexpensive yet secure container for household or commercial storage purposes. The container consists essentially of a box having a floor, parallel opposing sides, a roof, and closed ends, one of which is provided with a lockable door.

### BACKGROUND OF THE INVENTION

There many advantages and uses for a lightweight, inexpensive, transportable storage container. By itself, it can serve as a convenient closed storage unit for either indoor or outdoor use, to keep possessions secure against damage or theft. It would find use in a multitude of applications in the user's residence, vacation home, apartment or rental unit. It would also have many commercial applications in the hands of building contractors, utility companies, marina operators and caterers for both temporary and permanent on-site storage. Being light, it can be lifted and secured to the bed of a trailer or pickup truck to transport all kinds of equipment, particularly recreational equipment such as gear for tailgate parties and the like. Being inexpensive, it could be rented out to pickup truck and flat-bed trailer owners for one-way trips, much like a light utility trailer.

The simple basic design of the subject container lends itself to the inclusion of many useful details, such as exterior tie-downs for carrying a ladder, canoe, kayak or the like. Vents and windows can also be provided. Access to the container contents can be provided through a rear door, or through latching side access hatches.

For maximum utility, the container also has multiple tie-down points accessible from both within and without the container, weather-protected ventilation and door openings, removable window panels, and an aerodynamic shape to minimize parasitic drag while on a truck or trailer during transport at highway speeds.

Ease and economy of construction are additional important considerations. Desirably, the container may be manufactured in the form of modular panels which are assembled at the point of sale, or as a do-it-yourself project by the owner. Alternatively, the container may be formed as a one-piece blow molded plastic or molded fiberglass unit, and then split along a horizontal plane to form nesting half-sections for easy shipping and assembly.

### THE PRIOR ART

Others have approached the problem of providing a transportable storage unit or container in different ways. Blair Pub. No. US 2005/0173944 (Aug. 11, 2005) discloses a two-piece portable ice fishing shelter comprising a lower hull and cover unit which nests within the hull for transport to the point of use, where it is jointed together by suitable means. The cover shell includes windows and an openable and lockable door.

LaBore Pub. No. US 2006/0186643 (Aug. 24, 2006) discloses another ice fishing shelter which is carried on trailer wheels and by means of levers is lowered onto the ice for use.

Haskins U.S. Pat. No. 3,666,129 (May 30, 1972) discloses a trailered storage bin that is described as releasably and pivotally attached to its trailer so that it can be lowered to the ground for support. After erection, the bin is released and the trailer removed.

Krauss U.S. Pat. No. 7,128,330 (Oct. 31, 2006) discloses a caster-wheeled toolbox carried by a small low-boy trailer and lowered to the ground at the job site.

The prior art also discloses numerous storage bins adapted to fit into the bed of a pick-up truck. Typical examples of such containers are disclosed by Macaulay U.S. Pat. No. 6,742,825 (Jun. 1, 2004) (a forward-mounted toolbox); Scott U.S. Pat. No. 7,083,045 (Aug. 1, 2006) (a full-bed length ladder container or toolbox); Lovell U.S. Pat. No. 7,216,914 (May 15, 2007) (another full bed-length toolbox); San Paulo, et al., U.S. Pat. No. 7,219,942 (May 22, 2007) (a side-opening toolbox secured to the bed of the pick-up truck by J-bolts); Frasure, et al. U.S. Pat. No. 7,270,360 (Sep. 18, 2007) (a pick-up bed-mounted storage unit with a pull-out drawer); Tai U.S. Pat. No. 7,438,309 (Oct. 21, 2008) (another pull-out drawer truck-bed storage unit); and Senatore U.S. Pat. No. 7,455,312 (Nov. 25, 2008) (a wheeled trailer which collapses and slides on rails into the bed of a pick-up truck).

### A BRIEF DESCRIPTION OF THE DRAWINGS

In the drawings:

FIG. 1 is a perspective view of one embodiment of the container of the present invention showing how it fits into the bed of a conventional pick-up truck;

FIG. 2 is a side elevation of the container of FIG. 1 mounted on a trailer;

FIGS. 3a, 3b, 3c are side and end elevations of the container of FIGS. 1 and 2; and FIG. 3d is a plan view of the floor of that container;

FIG. 4 is a fragmentary cross-section of a ventilation port of the container shown in FIG. 3A;

FIG. 5 is a detail of a reinforced tie-down corner of the container of the previous figures;

FIGS. 6a and 6b are side and end elevations of an alternative embodiment of the invention having snap-in door and access panels;

FIG. 7 is a fragmentary cross-sectional view of the snap-in access panel of FIG. 6B; and

FIGS. 8a, 8b, and 8c are side and end elevations of another alternative embodiment of the invention incorporating nesting half-shells which are fastened together for use.

### A DETAILED DESCRIPTION OF THE INVENTION

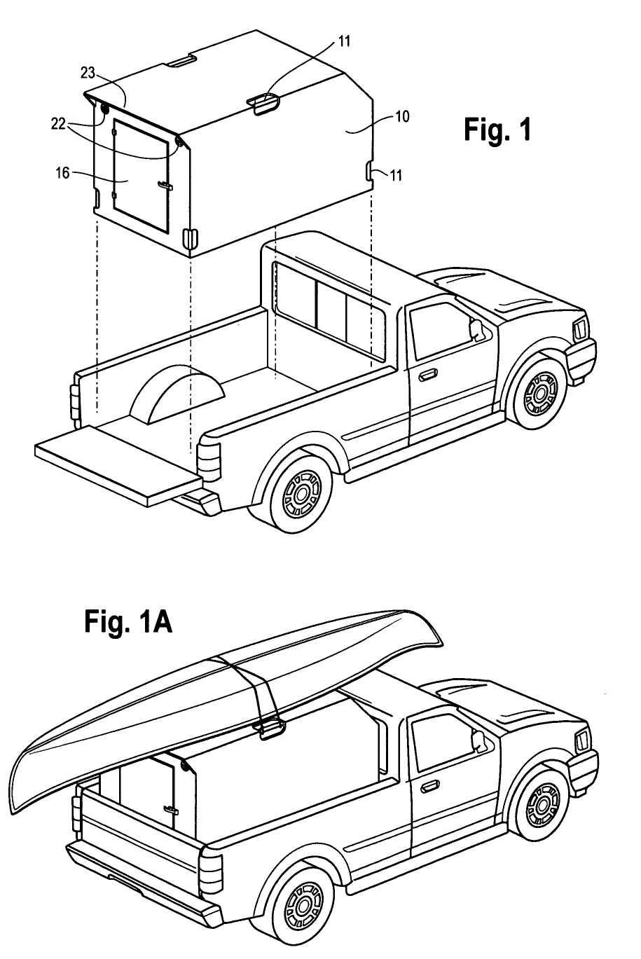

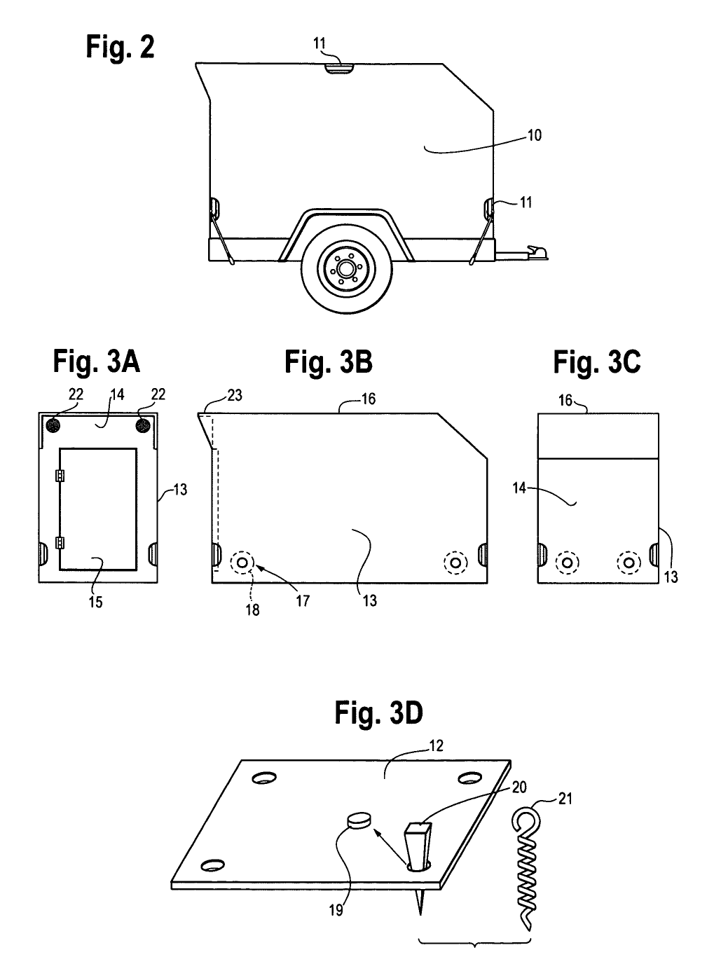

Referring to FIG. 1, there is shown a typical pick-up truck having an open bed with a flat floor, dropping tailgate, and wheel wells which intrude into the volume of the truck bed and thereby constrain the maximum width of any storage unit intended to be carried within it. Shown in FIG. 1 is one embodiment of the storage unit 10 of the present invention, positioned above the pick-up truck bed ready to be lowered into place. To secure the unit for transport, external tie-down hard-points or handles 11 are provided, as best shown in detail in FIGS. 3a, 3b, 3c, and FIG. 5.

It is an objective of the invention to permit the container to be assembled in about fifteen minutes or less using simple tools. The embodiment shown in FIGS. 3a, 3b, 3c, 3d and FIG. 5 is in essence a six-sided box having a floor 12, sides 13, ends 14 (one end including a door 15) and a roof 16. It may be constructed from any suitable materials such as plywood, foam-core board, molded plastic, molded fiberglass, or individual plastic panels which can be assembled by the end user. These six structural elements are then assembled and fastened by any suitable joining means (not shown), including but not limited to glue, nails, screws, quarter-turn Dzus® twist-lock fasteners and the like. Preferably, the unit 10 is manufactured and shipped in knocked-down form and is later assembled by a dealer at the point of sale, or by the purchaser, if provided with suitable hardware and simple assembly instructions.

As a feature of the invention, internal tie-down hard points 17 are also provided, as best shown in FIGS. 3a, 3b, 3c and 3d, which in the illustrated embodiment are large steel or plastic (such as nylon) washers 18 bonded to the surface of the container side and end walls, through which straps or cables may be passed to secure the contents of the container against movement.

A further feature of the invention is that the floor panel 12 (FIG. 3d) may be provided with spaced holes protected by knock-out plugs 19 which, when removed, permit stakes 20 to be driven through the holes into the ground to secure the unit from being tipped over by the wind. By using screw-in type anchor stakes 21, the unit can also be protected against theft, since removal of this type of stake requires access to the locked interior of the unit 10.

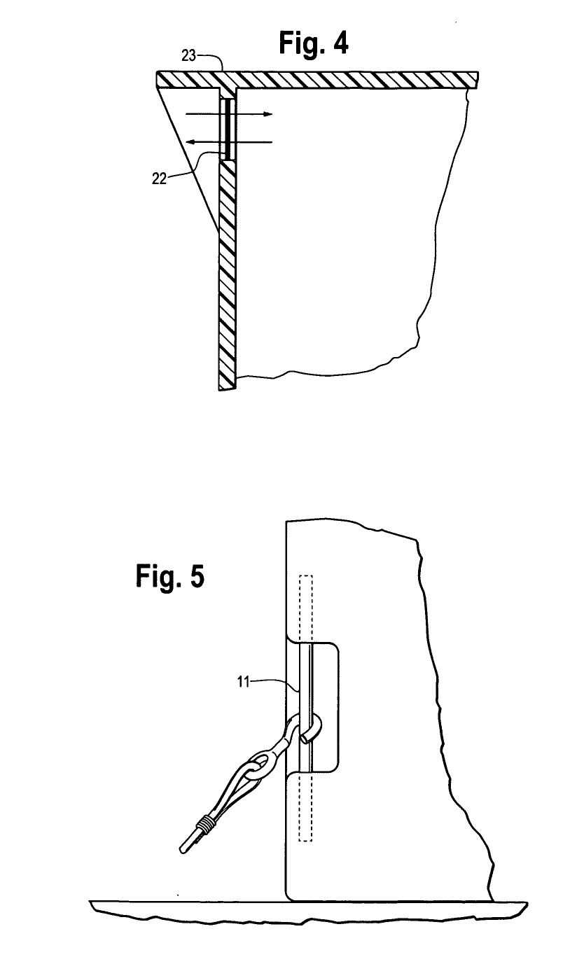

Another feature of the invention, best shown in FIGS. 1 and 4, are two or more screened ventilation ports 22 protected by an overhanging ledge 23 from rain and other precipitation. By providing two or more ports, preferably spaced from each other or on opposite sides of the container, a degree of flow-through or cross-ventilation is provided.

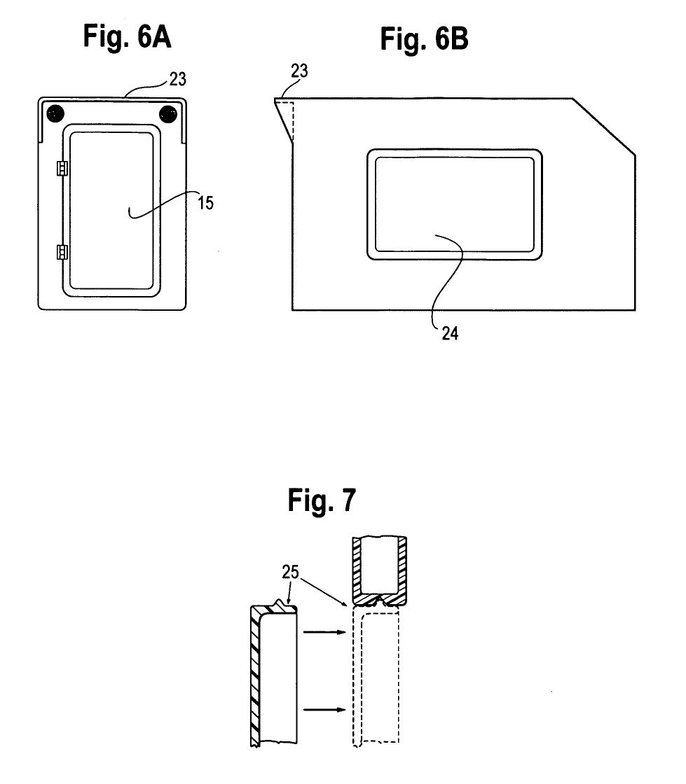

FIGS. 6a, 6b and 7 illustrate another feature of the invention. For use, the container 10a of the present invention is desirably provided with removable access panels 24, both on one or both side walls, and on the hinged door 15 as well. For ease of installation and removal, the side wall and door openings on the one hand, and the removable access panels on the other, have cooperating tongue-and-groove peripheral ridges 25 (FIG. 7) which allow them to be easily snapped in and out without the use of tools. The access panels can be transparent, screened, or solid opaque, as desired.

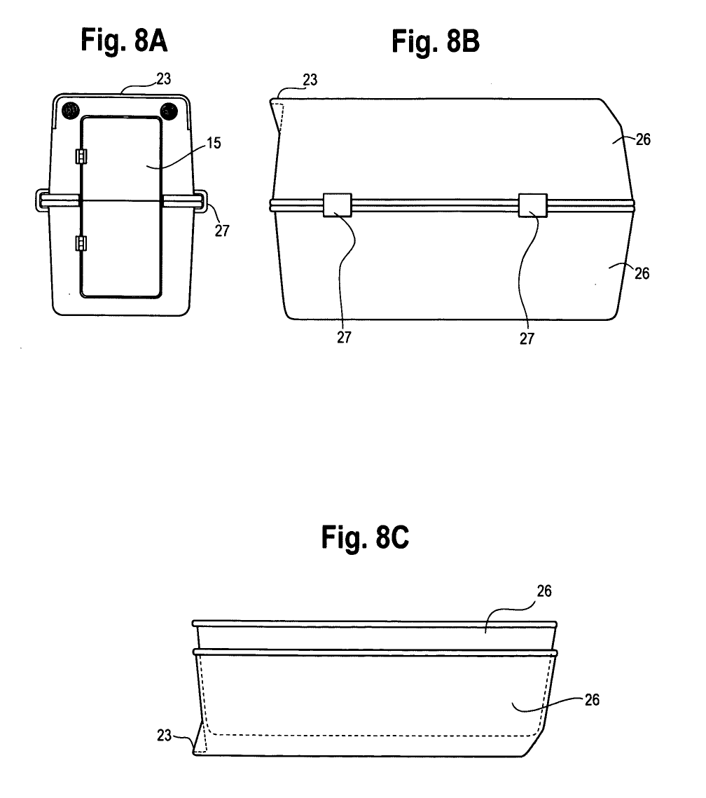

In yet another embodiment of the invention, illustrated in FIGS. 8a, 8b and 8c, the container is formed of molded (preferably blow-molded) heavy plastic or molded fiberglass, either as two congruent nesting units 26, or as a single integral unit which is later split apart on a horizontal plane. In either case the resulting components 26 may be nested together for shipment or storage as shown in FIG. 8c, and then fastened together at the point of sale or use to form a complete container. In the illustrated embodiment, molded-in bosses 27 are provided by which the mating half shells 26 may be fastened together with screws, bolts, clips, or any other suitable fastening means (not shown).

Other variations and embodiments of the invention may be recognized by those skilled in the art, without departing from the spirit and scope of the claims as set forth below.

I claim:

1. A compact portable multi-purpose storage container adapted for use with a wheeled carrier vehicle, such as a pick-up truck or light trailer, comprising
a rectangular floor sized to fit between the wheel wells of the bed of a carrier vehicle;
parallel opposing side walls and end walls cooperating with said floor, a roof cooperating with said floor, side walls and end walls;
joining means for connecting said floor, roof, side walls and end walls to form an closed rectilinear storage enclosure;
one of said side walls and end walls having a door opening with an openable door, said storage enclosure being characterized by
tie-down means for releasably securing said enclosure to the bed of a carrier vehicle,
internal attachment means for releasably securing objects to the interior of said enclosure,
external attachment means for releasably securing objects to the exterior of said enclosure, and
handle means for manually transferring said assembled enclosure enclosure to and from the cargo area of a carrier vehicle.

2. The storage container of claim 1 in which said floor, side walls, end walls and roof are formed from composite sheet material comprised of inner and outer nonporous sheets enclosing and attached to a rigid core, and having reinforced hard points for attachment to said joining means.

3. A storage container as defined by claim 1 which is formed as an integral unit from blow-molded plastic, and having a cut-in door opening enclosing and retaining said openable door.

4. A storage container as defined by claim 1 which is formed as an integral unit from molded fiberglass, and having a cut-in door opening enclosing and retaining said openable door.

5. The storage container of claim 1 in which one of said end walls is at least partially inclined from the vertical relative to the floor member for enhancing the aerodynamics of said container during motorized transport.

6. The storage container of claim 1 including ventilation means comprising at least two rain-shielded air passages communicating between the interior and exterior of said enclosure and providing cross-flow ventilation through the interior thereof.

7. The storage container of claim 1 in which said tie-down means comprise a plurality of reinforced through-hole passages from the interior to the exterior of said enclosure.

8. The storage container of claim 1 in which at least one of said side walls has a reinforced frame opening adapted to receive and retain a removable access panel component chosen from the group comprising: a transparent window panel, a screened panel, and an opaque blanking, panel.

9. The storage container of claim 8 in which each said removable access panel component is received and retained within said frame opening by snap-in means without requiring the use of tools.

10. The storage container of claim 1 in which said door panel has a reinforced frame opening adapted to receive and retain a removable door panel component chosen from the group comprising a transparent window panel, a screened panel, and an opaque blanking panel.

11. The storage container of claim 9 in which each said door panel component is received and retained within said door frame opening by snap-in means without requiring the use of tools.

12. The storage container of claim 10 in which said floor is provided with at least one opening containing a knock-out plug which, when removed, permits the container to be secured onto a supporting surface by a stake.

13. A compact portable multi-purpose storage container adapted for use with a wheeled carrier vehicle, such as a pick-up truck or light trailer, comprising
a rectangular floor sized to fit between the wheel wells of the bed of a carrier vehicle;
parallel opposing partial lower side walls and partial lower end walls cooperating with said floor;
said floor, partial lower side walls and partial lower end walls being formed as an integral unit and defining a first integral structural component;
a rectangular roof congruent with said rectangular floor;
parallel opposing partial upper side walls and partial upper end walls cooperating with said roof;
said roof, partial upper side walls and partial upper end walls being formed as an integral unit and defining a second integral structural component; and
joining means for connecting said first and second integral structural components to form a closed container.

14. The storage container of claim 13 in which said first and second integral structural components nest together for compact storage and shipment.
